(19) United States
(12) Patent Application Publication
(10) Pub. No.: US 2021/0108460 A1
(43) Pub. Date: Apr. 15, 2021

(54) Pet Portal

(71) Applicant: Suzanne Lain, Garner, NC (US)

(72) Inventor: Suzanne Lain, Garner, NC (US)

(21) Appl. No.: 17/038,400

(22) Filed: Sep. 30, 2020

Related U.S. Application Data
(60) Provisional application No. 62/914,586, filed on Oct. 14, 2019.

(51) Int. Cl. E06B 7/32; A01K 29/00

(52) U.S. Cl. CPC E06B 7/32; A01K 29/00

(57) ABSTRACT

Disclosed is pet portal that allows various sizes of pets to easily enter/exit a house through a baffle opening. The baffle opening made out a flexible insulating material that bounces back into its original shape after being disturbed when an animal passes through the portal. While in the closed orientation the baffle material blocks the outdoor environment, maintaining a constant and comfortable temperature inside the house.

This non-provisional application claims priority to and fully incorporates provisional application Ser. No. 62/914,586 filed on Oct. 14, 2019.

### FIELD OF INVENTION

The invention is an alternative to traditional pet doors.

### BACKGROUND OF THE INVENTION

People like to let their pets come and go quickly from inside the house at all hours and during all seasons. Many types and styles of pet doors are on the market to accommodate this need. These previous doors have many drawbacks. Some pet doors have an opening without any cover, which when not in use, results in drafts/outdoor environment and insects entering the house. Many traditional pet doors employ a swinging rigid rectangular flap made of either plastic, vinyl, or rubber. To minimize drafts/outdoor environment from coming indoors, they either rely on the stiffness/rigidity and the weight of the flap to close the opening after a pet goes through, or they may utilize magnets or other mechanical means to seal the opening closed. These traditional pet doors also allow insects to invade homes too easily. Some more modern cat doors employ a four-way mechanical hard plastic flap which often breaks over time and requires human intervention to lock/unlock; electromagnetic technology which requires a cat to wear a collar and for the magnet on the collar to be facing forward at all times; or microchip-locking mechanisms which are expensive and require cats to have an embedded microchip.

What is needed is a pet portal that allows various sizes of pets to easily enter/exit a house through an opening, but at the same time, that blocks the outdoor environment, maintaining a constant and comfortable temperature inside the house all year long (thus, saving valuable energy and money) and prevents flying insects from entering.

### SUMMARY OF THE INVENTION

Disclosed is a pet portal that utilizes a baffle design for the opening. The baffle is comprised of a flexible insulating material and is cut in such a way that it flexes both inward and outward as a cat/small pet comes and goes through it, and then springs back into place. The baffle design is biased to be in the closed orientation with the triangular flaps sealing as they mate with one another, except when a pet is passing through.

### SHORT DESCRIPTION OF FIGURES

FIG. 1A shows an embodiment of the pet portal in a window opening in the closed orientation.

FIG. 1B: shows an embodiment of the pet portal in a window opening with a pet passing through.

FIG. 1C shows an inner protective layer covering opening of the base with the frame and baffle opening removed.

FIG. 2: shows an embodiment of the pet portal in the closed orientation when incorporated into a door.

FIG. 3A is an exploded view of slide unit insert.

FIG. 3B shows the slide unit being insert in an opening.

### DETAILED DESCRIPTION

The pet portal of the claimed invention can be incorporated into either a window, a wall, or an interior/exterior door or wall of a house. Unlike traditional pet doors that are comprised of a hard, large flapping rectangular piece of plastic, vinyl, or rubber, or ones that have no barrier at all, the pet portal of the claimed invention utilizes a baffle style opening made of flexible insulating material that can easily be traversed by a pet, but doesn't require any accessories to enable a closed orientation when not in use. The closed orientation minimizes the entry of harsh weather and flying insects into a home.

The pet portal of the claimed invention is comprised of a baffle opening made out a flexible insulating material that bounces back into its original shape after being disturbed when an animal passes through the portal. The flexible insulating material is cut into triangular flaps such that the opening resembles a sliced pie where all points meet in the center. This design innately forms a barrier when in the closed orientation. The flexible insulating material can be attached by any means known in the art to a frame shaped to accommodate the shape of the baffle opening. This frame can in turn be attached to an outer surface a base support for use with a window opening or can be directly inserted into an opening in the of a door or window insert, they themselves acting as a base support. A frame that attaches to the outer surface of a base support can be various styles and shapes and can be plain, covered with decals, fabric, or other material. Preferably for the safety of the animals, an inner protective ring is then seated inside the base or door opening and attached to the base or door using any method known to those in the art. The purpose of the inner protective is to a) act as the sides of a tunnel through which the pet travels when the frames are mounted on an interior hollow door, and b) act as a shield to protect pets against any wood or metal splinters when the frames are mounted on a solid wood or insulated metal exterior door.

The baffle opening can be configured as a single baffle opening or a double baffle opening. The gap between the baffle openings will only be the width of the door, wall or window in which the pet portal is being used. Because of the baffle design, pets are able to navigate these openings quite easily. The advantage of using the double baffle opening configuration is that there are now two barriers to prevent weather/insects from entering the house if being used to provide access to the exterior of the house. Optionally only a single piece of flexible insulating material can be used that is attached to only one of the side surfaces while the other side has a non-barrier opening. The baffle opening can be sized to accommodate pets of any size. The preferred shape of the baffle opening is a vertical ellipse as shown in the figures, however these is non-limiting examples, and any shape opening (oval, circular, square, rectangular, simple polygon or a partial of any shape that abuts against a bottom plane such as a window sill or a door frame) is covered by this disclosure.

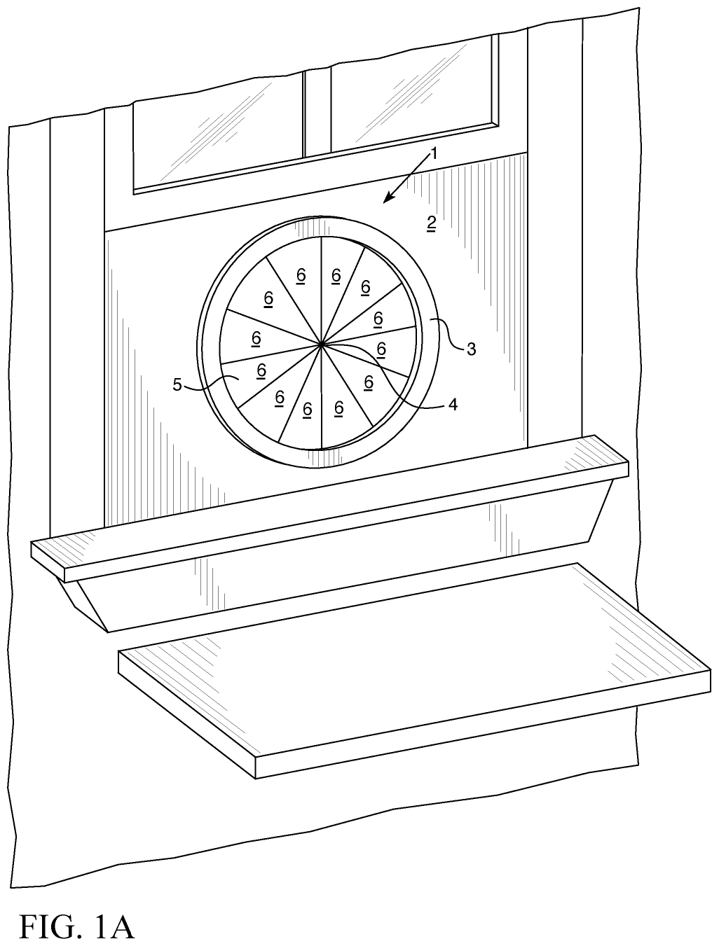

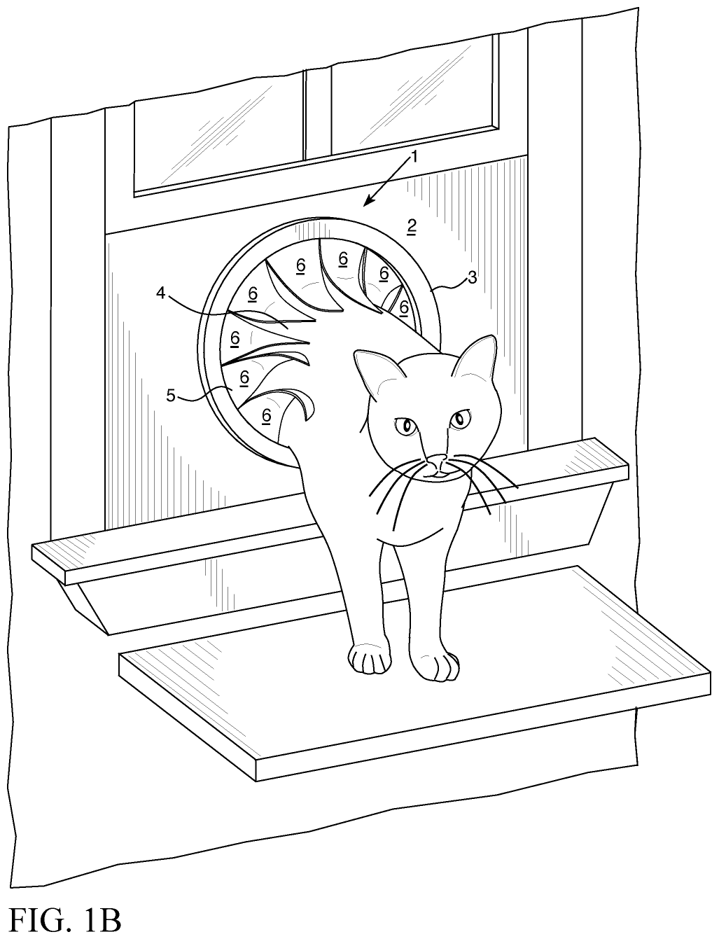

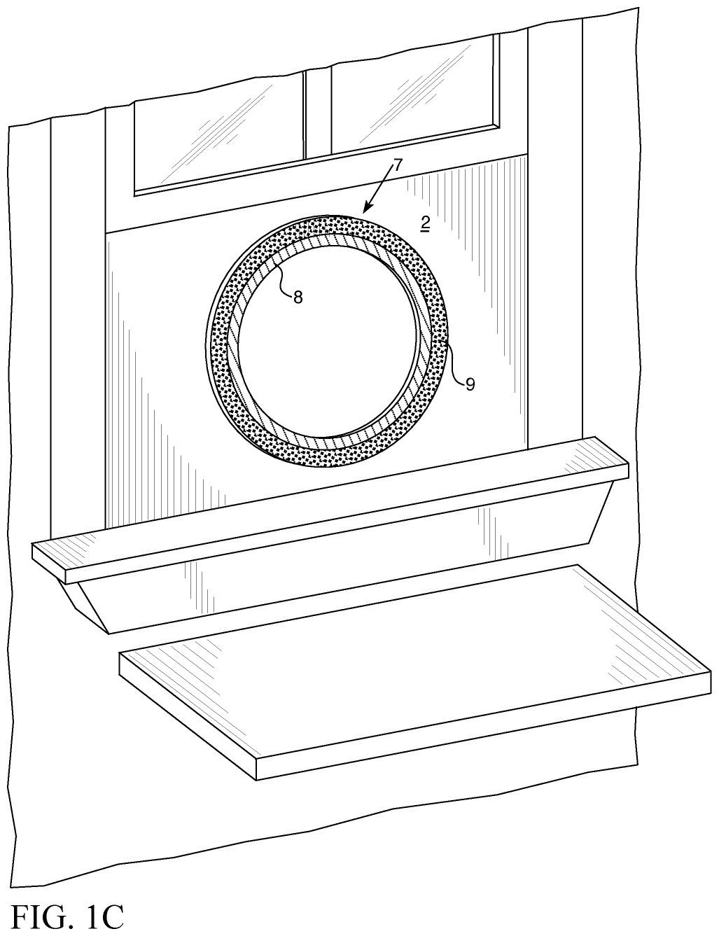

FIGS. 1A-1B disclose pet portal 1 for use with a window opening, with 1B and 1C showing an interior portal configuration shown from an interior view. Pet portal 1 is comprised of a base insert 2, external frame 3, and baffle material sheet 5 with baffle opening 4. Base insert 2 has a central opening that is sized to accommodate an animal a size of typical household pet and base insert 2 is comprised of any suitable solid material cut to the size of a window opening. External frame 3 had an elliptical opening corresponding in size and shape of the diameter of the opening in the base insert 2 and can be comprised of any suitable material. Baffle opening 4 is comprised of triangular flaps 6 that are cut like a pie so that all central angled points meet in the center point to form a barrier when in the closed orientation. Baffle material sheet 5 is comprised of a flexible insulating material that is rigid enough so that the baffle is biased to be in the closed position except when a pet is passing through and is pliable enough to allow a typical household pet to navigate through the baffle opening. External frame 3 can attach to baffle material sheet 5 by any means known in the art. Baffle opening 4 is corresponding in size and shape of the diameter of the opening in the base insert 2, alternatively baffle opening 4 could be slightly smaller to allow for an uncut edge to provide stability. Alternatively, the base inserted can be used with a door opening rather than a window opening.

As seen FIG. 1C, optionally, an inner protective layer 7 has a diameter corresponding in size and shape to a diameter in an opening in a base and the inner protective layer 7 has an interior width piece 8 that corresponds to the width of the base insert 2, the inner protective layer 7 having external flaps 9 attached to the interior width piece 8, the external flaps 9 being capable of attaching to the base window insert via an area adjacent to the base opening. Inner protective layer 7 can be comprised of any material suitable. Inner protective layer 7 can attach to the base window insert by any means known in the art. Preferably, inner protective layer 7 is a circular piece of strong but flexible plastic that forms a safe pass-through along the inside of the base opening, which opening is hidden after the external frame(s) are attached.

Here is the portal configuration is shown on the interior, optionally the portal configuration can be placed on the exterior of the base window insert. Either configuration forms a single baffle portal. Alternatively, portal configuration can be placed on both the exterior and the interior forming a double baffle portal.

As shown here, the baffle material sheet 5 is positioned in between the external frame 3 and base insert 2. Optionally (not shown), the baffle material sheet 5 can be positioned the outward facing surface of the external frame 3, wherein a stabilizer ring (not shown) corresponding size and shape of each external frame 3 is placed on the outward facing surface of the baffle material sheet 5, the stabilizer ring aligning with its corresponding external frame.

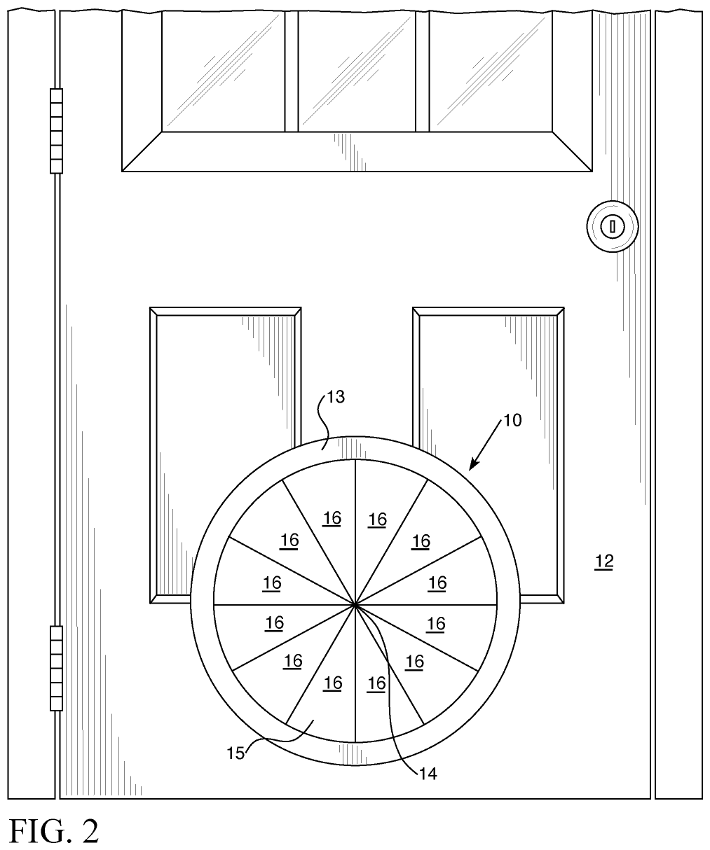

FIG. 2 disclose pet portal 10 for use with a door 12 acting as a base showing an interior portal configuration shown from an interior view. Pet portal 10 is comprised external frame 13, and baffle material sheet 15 with baffle opening 14. Door 12 has an opening that is sized to accommodate an animal a size of typical household pet. External frame 13 had an elliptical opening corresponding in size and shape of the diameter of the opening in the door 12 and can be comprised of any suitable material. Baffle opening 14 is comprised of triangular flaps 16 that are cut like a pie so that all central angled points meet in the center point to form a barrier when in the closed orientation. Baffle material sheet 15 is comprised of a flexible insulating material that is rigid enough so that the baffle is biased to be in the closed position except when a pet is passing through and is pliable enough to allow a typical household pet to navigate through the baffle opening. External frame 13 can attach to baffle material sheet 15 by any means known in the art. Baffle opening 14 is corresponding in size and shape of the diameter of the opening in the door 12, alternatively baffle opening 14 could be slightly smaller to allow for an uncut edge to provide stability.

Here is the portal configuration is shown on the interior, optionally the portal configuration can be placed on the exterior of the door base. Either configuration forms a single baffle portal. Alternatively, portal configuration can be placed on both the exterior and the interior forming a double baffle portal.

As shown here, the baffle material sheet 15 is positioned in between the external frame 13 and door 12. Optionally (not shown), the baffle material sheet 15 can be positioned the outward facing surface of the external frame 13, wherein a stabilizer ring (no shown) corresponding size and shape of each external frame 13 is placed on the outward facing surface of the baffle material sheet 15, the stabilizer ring aligning with its corresponding external frame.

Similar to the window insert embodiment, in this door embodiment, preferably an inner protective layer that has a diameter corresponding in size and shape to a diameter in the opening in the door and that has an interior width piece that corresponds to the width of the door is used. The inner protective layer has external flaps attached to the interior width piece, with the external flaps being capable of attaching to the door via an area adjacent to the door base opening. Inner protective layer can be comprised of any material suitable. Preferably, inner protective layer is a circular piece of strong but flexible plastic that forms a safe pass-through along the inside of the base opening, which opening is hidden after the external frame(s) are attached.

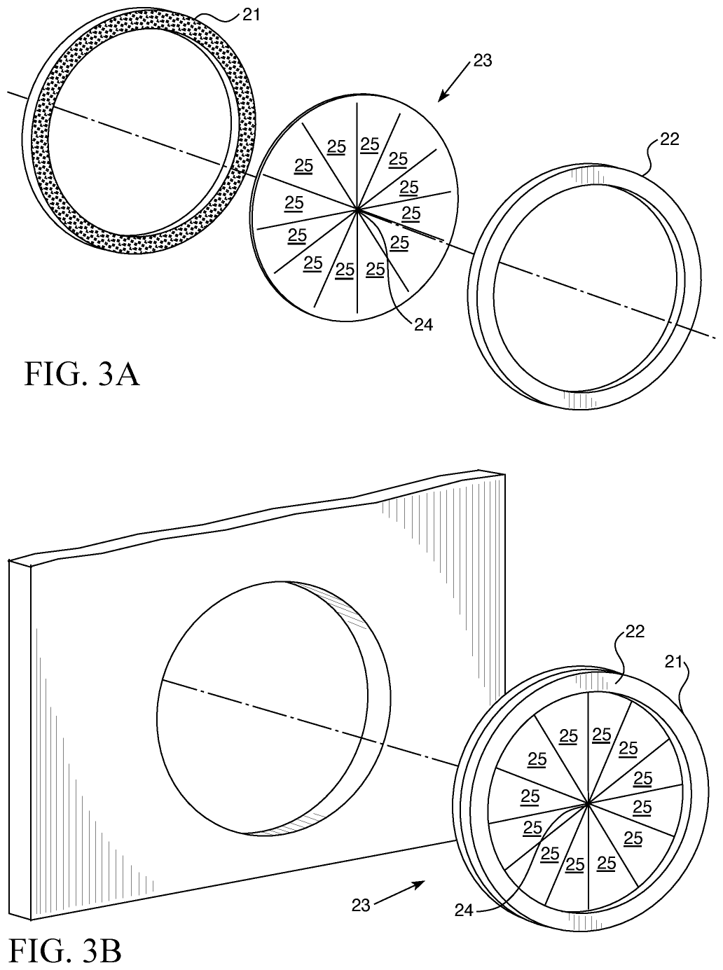

FIG. 3A-3B discloses an independent portal unit that can be inserted into an opening such as an opening in a door. Pet portal unit 20 is comprised of an interior frame 21 with an elliptical opening corresponding in size and shape to a diameter of an opening in the base and capable of being inserted in an inner diameter in the opening in the base. The elliptical opening being sized to accommodate an animal a size of typical household pet. Pet portal unit 20 has at least one attachment frame 22 with an outer diameter and an interior diameter with an elliptical opening, the outer diameter corresponding in size and shape to the outer diameter of the interior frame 21, the attachment frame 22 capable of being inserted in the inner diameter in the opening in the base, the elliptical opening in the attachment frame 22 corresponds in size and shape to the elliptical opening of the interior frame.

The interior side of the attachment frame 22 is connected to baffle material sheet 23, which in turn is connected to the interior frame 21 such that the elliptical opening of the attachment frame 22 and the elliptical opening of the interior frame are aligned and the outer diameter of the attachment frame 22 and the outer diameter interior frame 21 are aligned. The attachment frame 22 being attached to a baffle material sheet 23, the baffle material sheet being comprised of baffle opening 24, the baffle opening 24 being elliptical in shape and the baffle opening 24 having a center point and being comprised of a plurality of triangular flaps 25, each triangular flap comprising a central angled shaped point such that each one of the central angled shaped points meet in the center point of the baffle opening 25 to form a barrier when in a closed orientation, the baffle material sheet 23 being comprised of a flexible insulating material, the baffle opening 24 being sized to accommodate an animal a size of a typical household pet and whereby the flexible insulating material is pliable enough to allow a typical household pet to navigate through the baffle opening 24, and whereby the flexible insulating material is rigid enough so that the baffle opening 24 is biased to be in the closed orientation when not in use.

As shown here, the baffle material sheet 23 is positioned on the inward facing side of the attachment frame 22. In an alternative configuration, the baffle material sheet can be attached to the outward facing of the attachment ring, and a stabilizer ring (not shown) corresponding size and shape of each attachment frame 22 can be placed on the outward facing surface of the baffle material sheet 23, the stabilizer ring aligning with its corresponding outward surface of the attachment frame.

Here is the portal configuration is shown that when inserted the baffle opening 24 would be facing the exterior, optionally the portal configuration can be reversed where the baffle opening 24 would be on the interior of the door base. Either configuration forms a single baffle portal. Alternatively, portal configuration can be placed on both the exterior and the interior facing sides forming a double baffle portal.

Similar to the base insert embodiments, n inner protective layer that has a diameter corresponding in size and shape to a diameter in the opening in the door and that has an interior width piece that corresponds to the width of the door can be used. The inner protective layer has external flaps attached to the interior width piece, with the external flaps being capable of attaching to the door via an area adjacent to the door base opening. Inner protective layer can be comprised of any material suitable. Preferably, inner protective layer is a circular piece of strong but flexible plastic that forms a safe pass-through along the inside of the base opening, which opening is hidden after the external frame(s) are attached. Here the inner protective layer can be used to ease the insertion of the pet portal unit 20 when assembled.

Typically, the base insert can fit into a single hung or double hung window opening or into an opening cut out of door acting as base. Base insert can be any material including various polymers, wood, treated wood, or a rust resistant metal, and any material suitable for use in this disclosure. Preferably, the frame is comprised of a durable polycarbonate or any other high-impact plastic. The frame needs to be durable, sturdy, weather resistant, and capable of receiving the baffle material sheet with a baffle opening, said baffle material sheet being comprised of flexible insulating material. If a frame/base has exterior and interior pieces, the exterior frame/base and interior frame/base can be comprised of the same material or comprised of different materials if the end user wishes for either piece to better match the side of the door/wall or window to which it is attached. Attachment of the frame to a base insert or to a door can be done by any means known to those with skill in the art. Alternatively, a portal unit can be fitted to insert into a hole cut in a door or a wall.

The baffle opening material is comprised of a flexible insulating material. Some insulating materials may be a dual composition comprising an interior insulation covered with an outer layer to contain the insulation and to provide structure to form the baffle design. Other insulating materials may be comprised of a single composition that both insulates and that provides structure to form the baffle design. The insulating material whether single composition or dual composition, needs to be flexible enough to allow a small animal to easily pass through, but rigid enough to spring back into a fully closed orientation. The size and shape of the baffle opening can vary based on the size/shape of the animal the portal is intended for. Preferably the outer layer of the insulating material or the single composition insulating material is also durable and weather resistant. Some non-limiting examples of single composition flexible insulating materials include various rubber and vinyl formulations. Some non-limiting examples of interior insulation include polyethylene bubble film, polyester fiber batting, Jute fiber batting, cotton batting, fiberglass, wool, cellulose, or flexible foam. Some non-limiting examples of an outer layer composition include metal/foil outer layer, denim, or any viable type of flexible polymer. The baffle opening can be single baffle configuration, or a double baffle configuration as described above.

After installation of the pet portal, pets can freely move through the baffle opening. While not in use the baffle opening remains in the closed orientation blocking out the weather and flying insects. The pet portal doesn't require human interaction or accessories such as magnets, mechanical means, etc. for the pet portal to function properly.

Although the above illustrative embodiments of the claimed invention have been described herein with reference to the accompanying drawings, it is to be understood that the invention is not limited to those precise embodiments, and that various other changes and modifications may be affected therein by one skilled in the art without departing from the scope or spirit of the invention. Accordingly, the drawings and description are to be regarded as illustrative in nature, and not as restrictive.

1. A portal comprising:
at least one external frame, the external frame having an outer diameter and an interior diameter with an opening, the opening of the interior diameter corresponding in size and shape to the opening in the base, the inner surface being capable of attaching to the base via an area adjacent to the base opening such that the opening of the interior diameter is aligned with the opening in a base,
the at least one external frame being attached to a baffle material sheet, the baffle material sheet being comprised of baffle opening, the baffle opening being in shape and the baffle opening having a center point and being comprised of a plurality of triangular flaps, each triangular flap comprising a central angled shaped point such that each one of the central angled shaped points meet in the center point of the baffle opening to form a barrier when in a closed orientation, the baffle material sheet being comprised of a flexible insulating material, the baffle opening being sized to accommodate an animal a size of a typical household pet,
whereby the flexible insulating material is pliable enough to allow a typical household pet to navigate through the baffle opening, and whereby the flexible insulating material is rigid enough so that the baffle opening is biased to be in the closed orientation when not in use.

2. The portal of claim 1, whereby the base is comprised of an exterior side and an interior side, a first external frame being attached to the exterior side and a second external frame being attached to the interior side via the inner surface, whereby when attachment of both external frames is achieved, a double baffle portal is formed.

3. The portal of claim 1 wherein the base is a door.

4. The portal of claim 1 wherein the base is an insert.

5. The portal of claim 1, wherein the external frame having an exterior side, the baffle material being attached to the exterior side of the external frame wherein the baffle material has an outward facing surface and wherein a stabilizer corresponding size and shape of the external frame is placed on an outward facing surface of the baffle material aligning with the external frame.

6. The portal of claim 2, wherein the first external frame having an exterior side and the second external frame having an exterior side, the baffle material being attached to each exterior side, wherein the baffle material has an outward facing surface and wherein a stabilizer corresponding size and shape of each external frame is placed on the outward facing surface of the baffle material aligning with its corresponding external frame.

7. The portal of claim 1, further comprising an inner protective layer, the inner protective layer having a diameter corresponding in size and shape to a diameter in an opening in a base, the opening in the base being sized to accommodate an animal a size of typical household pet, the inner protective layer having an interior width piece that corresponds to the width of the base, the inner protective layer having external flaps attached to the interior width piece, the external flaps being capable of attaching to the base via an area adjacent to the base opening.

8. A portal comprising:
an interior frame comprising an outer diameter and an interior diameter with an opening, the outer diameter corresponding in size and shape to a diameter of an opening in a base, the interior frame capable of being inserted in an inner diameter in the opening in the base, the opening being sized to accommodate an animal a size of typical household pet,
at least one attachment frame with an outer diameter and an interior diameter with an opening, the outer diameter corresponding in size and shape to the outer diameter of the interior frame, the attachment frame capable of being inserted in the inner diameter in the opening in the base, the opening in the attachment frame corresponding in size and shape to the opening of the interior frame, the attachment frame having an exterior side and an interior side;
the interior side of the attachment frame being capable of connecting to the interior frame such that the opening of the attachment frame and the opening of the interior frame are aligned and the outer diameter of the attachment frame and the outer diameter interior frame are aligned,
the attachment frame being attached to a baffle material sheet, the baffle material sheet being comprised of baffle opening, the baffle opening being in shape and the baffle opening having a center point and being comprised of a plurality of triangular flaps, each triangular flap comprising a central angled shaped point such that each one of the central angled shaped points meet in the center point of the baffle opening to form a barrier when in a closed orientation, the baffle material sheet being comprised of a flexible insulating material, the baffle opening being sized to accommodate an animal a size of a typical household pet,
whereby the flexible insulating material is pliable enough to allow a typical household pet to navigate through the baffle opening, and whereby the flexible insulating material is rigid enough so that the baffle opening is biased to be in the closed orientation when not in use.

9. The portal of claim 8 wherein the interior frame comprises a first surface and a second surface, wherein a first attachment frame is attached to the first surface and a second attachment frame is attached to the second surface forming a single unit, said single unit capable of being inserted into the opening in the base forming a double baffled portal.

10. The portal of claim 8 wherein the base is a door.

11. The portal of claim 8 wherein the base is an insert.

12. The portal of claim 8, wherein the attachment frame having an exterior side, the baffle material being attached to the exterior side of the attachment frame wherein the baffle material has an outward facing surface and wherein a stabilizer corresponding size and shape of the attachment frame is placed on an outward facing surface of the baffle material aligning with the attachment frame.

13. The portal of claim 9, wherein the first attachment frame having an exterior side and the second attachment frame having an exterior side, the baffle material being attached to the each exterior side, wherein the baffle material has an outward facing surface and wherein a stabilizer corresponding size and shape of each attachment frame is placed on the outward facing surface of the baffle material aligning with its corresponding attachment frame.

14. The portal of claim 8, further comprising an inner protective layer, the inner protective layer having a diameter corresponding in size and shape to a diameter in an opening in a base, the opening in the base being sized to accommodate an animal a size of typical household pet, the inner protective layer having an interior width piece that corresponds to the width of the base, the inner protective layer having external flaps attached to the interior width piece, the external flaps being capable of attaching to the base via an area adjacent to the base opening.
